(19) United States
(12) Patent Application Publication
(10) Pub. No.: US 2009/0150602 A1
(43) Pub. Date: Jun. 11, 2009

(54) MEMORY POWER CONTROL

(75) Inventor: William Sauber, Georgetown, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 11/953,949

(22) Filed: Dec. 11, 2007

(51) Int. Cl. G06F 12/00

(52) U.S. Cl. 711/105; 711/E12.083

(57) ABSTRACT

In a memory device to store information, the device includes a memory core to store information, a memory controller to control storage and retrieval of the information, and a regulator coupled to the memory controller and the memory core, wherein the regulator is operable to adjust an internal voltage to the memory core in response to commands from the memory controller.

### BACKGROUND

The present disclosure relates generally to information handling systems, and more particularly to memory power control for an information handling system (IHS).

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Portable IHSs generally rely on battery power to run operations during times of portability of the IHS. With the increasing processor capability and increasing components, power usage of portable IHSs is increasing. However, battery capacity is not increasing as fast as the power demand is increasing. Therefore, energy savings for the portable IHS is advantageous for improving overall performance of the portable IHS.

A problem with power usage for higher performance IHSs is that higher performance (e.g., higher processor and memory speeds) increases power use of the IHS. In other words, maximum memory (e.g., dynamic random access memory (DRAM)) speed is dependent on voltage at the DRAM. A higher voltage allows higher memory speeds. Thus, as higher memory speeds are required, higher voltages and higher power usage is likely. DRAMs may have on-die regulators that allow for lowering a supply voltage to a portion of the device and some regulators may be set to different levels for different speed grades through fusing. However, a memory controller does not traditionally have any way to control internal memory voltage.

Accordingly, it would be desirable to provide an improved memory power control to reduce power consumption of the memory during periods of low processing demand which avoids the problems set forth above.

### SUMMARY

According to one embodiment, in a memory device to store information, the device includes a memory core to store information, a memory controller to control storage and retrieval of the information, and a regulator coupled to the memory controller and the memory core, wherein the regulator is operable to adjust an internal voltage to the memory core in response to commands from the memory controller.

### BRIEF DESCRIPTION OF THE DRAWINGS

FIG. 1 illustrates a block diagram of an embodiment of an information handling system.

FIG. 2 illustrates a block diagram of an embodiment of an information handling system.

FIG. 3 Illustrates a block diagram of an embodiment of a dynamic random access memory.

FIG. 4 illustrates a flow diagram of an embodiment of a memory control method.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

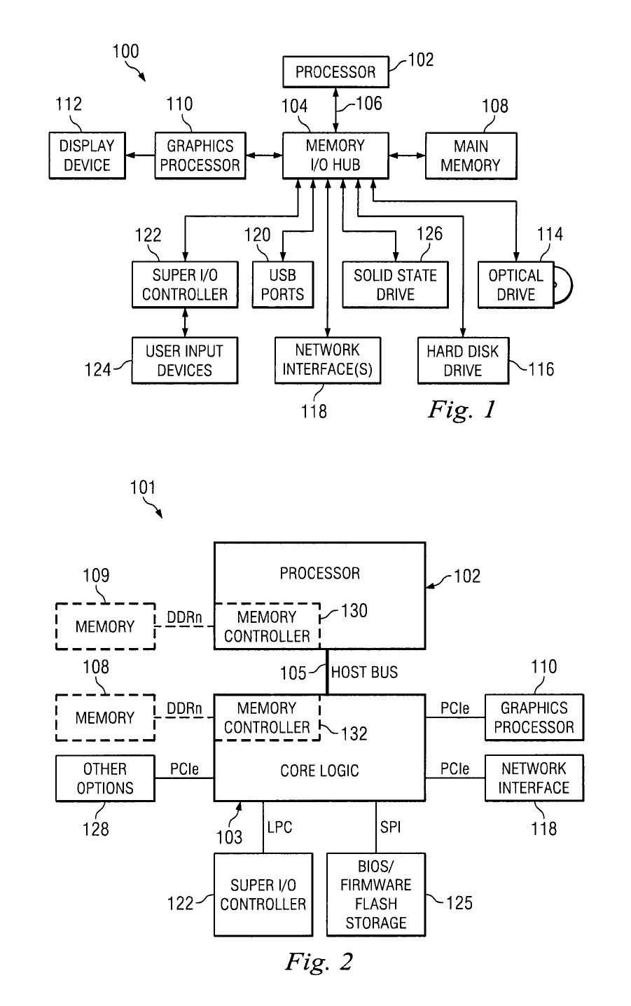

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in addition to main memory 108, the optical drive 114, and a hard disk drive 116. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

FIG. 2 is a block diagram of an embodiment of an IHS 101. This IHS 101 includes a processor 102 coupled with a core logic 103 via a host bus 105. The IHS 101 also includes a memory 108 coupled with a memory controller 132 via double data rate (DDRn) communication or a memory 109 coupled with a memory controller 130 via DDRn communication. The memory controllers 130 and 132 communicate with the memory 108 and 109 to store, refresh, and retrieve information in the memory 108 and 109. It is understood that information communications other than DDRn communication may be used to couple the memory controllers 130 and 132 with the memory 108 and 109. The memory controllers 130 and 132 control operations for the memory 108 and 109. However, the controllers 130 and 132 may be located on board with the memory 108 and 109. In an embodiment, the commonly understood PC interface express (PCIe) communication may couple the graphics processor 110, the network interface 118, and/or other options 128 with the core logic 103. In an embodiment, the commonly understood low pin count (LPC) communication bus may couple the super I/O controller 122 with the core logic 103. In an embodiment, the commonly understood serial peripheral interface (SPI) communication bus may couple the system BIOS/firmware storage 125 with the core logic 103. It is understood that the communication systems DDRn, PCIe, LPC, and SPI may be replaced, modified, or used to coupled different portions of the IHS 100, 101.

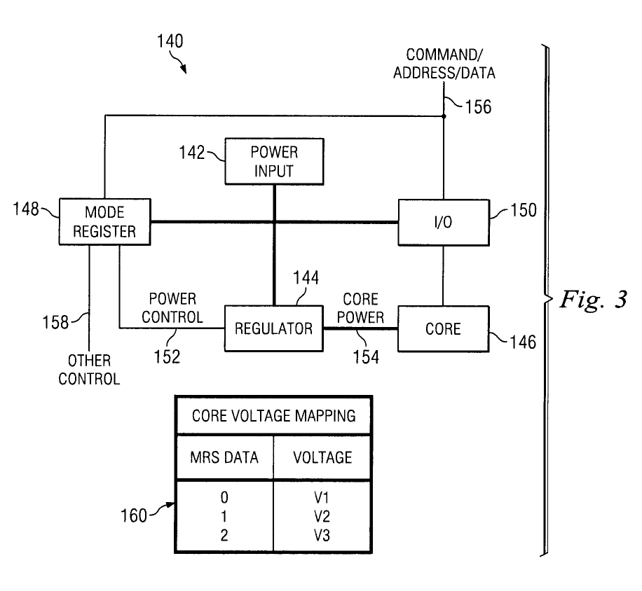

FIG. 3 is a block diagram of an embodiment of a memory device 140. The memory 140 may be used as memory 108 or memory 109, as illustrated in FIGS. 1 and 2. The memory 140 may also be used in other ways. In an embodiment, the memory 140 may be random access memory (RAM) or dynamic random access memory (DRAM).

The memory 140 is powered by a power input 142 that may be coupled to a regulator 144, a mode register 148, and/or a memory input/output (I/O) logic 150. Mode register bits may be used to control various aspects of the memory 140 operation. The power input 142 provides electrical power to the memory device 140. In an embodiment, the power input 142 provides a substantially stable direct current (DC) voltage to the memory device 140. The regulator 144 receives power from the power input 142 and regulates the value of the voltage supplied to the memory core 146 via a core power bus 154. In an embodiment, the regulator 144 receives a power control signal 152 from the mode register 148. As shown in the core voltage mapping table 160, the mode register signal data (MRS data) has a plurality of values (e.g., 0, 1, 2, . . . n) communicated from the mode register 148 to the regulator 144 via the power control signal 152. As the power control signal 152 changes value, the regulator 144 receives the changed value in power control signal 152 and modifies, adjusts, or otherwise changes the voltage value (e.g., V1, V2, V3, . . . Vn) provided to the core 146 via the core power bus 154. As the voltage to the core 146 is reduced, performance of the memory device 140 may be reduced and consequently the power consumed by the memory device 140 may decrease, thereby saving power for the IHS 100, 101.

The mode register 148 may receive a command/address/data 156 and/or an other control data signal 158 to use to determine an output value to communicate to the regulator 144. Thus, as the command/address/data signal 156 and/or the other control data signal 158 change, the mode register 148 may modify, adjust, or otherwise change the output value to communicate to the regulator 144. As such, the mode register 148 may cause the regulator 144 to increase or decrease the voltage supplied to the core 146 as a variety of other factors such as, processor performance, processor speed, and/or a variety of other factors change. Therefore, if the use of the memory 140 and/or the use of the processor 102 decreases (e.g., the IHS 100, 101 is not in use), the power to the memory 140 may be conserved.

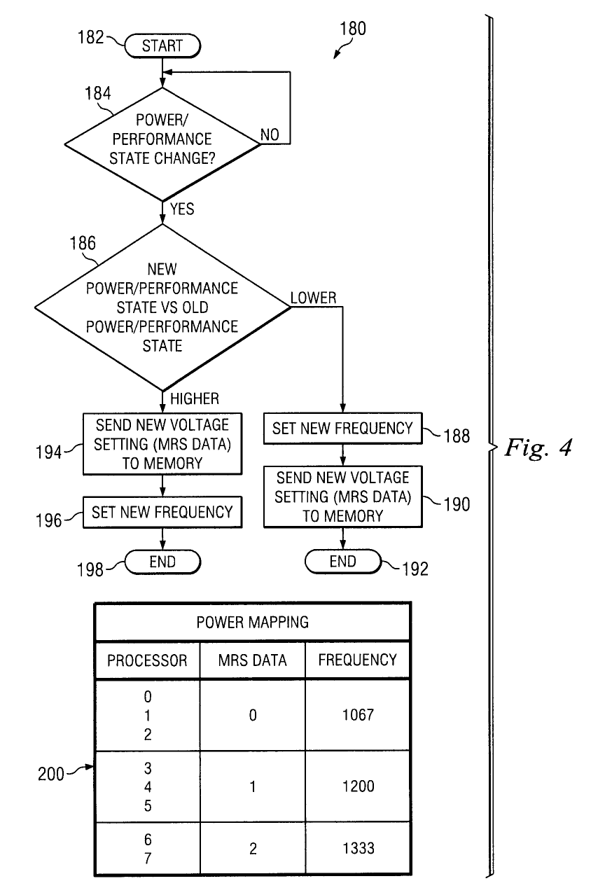

FIG. 4 is a flow diagram of an embodiment of a memory control method 180. The method 180 starts at 182 where the IHS 100, 101 is operating a given power/performance state such as, while the IHS 100, 101 is in use for processing information. The method 180 then proceeds to decision block 184 where the method inquires as to whether the power/performance state has changed. If the power/performance state has not changed, the method 180 returns to decision block 184 to await a change in power/performance state. If the power/performance state has changed, the method 180 proceeds to decision block 186 where the method 180 inquires as to whether the change in power/performance state goes higher or lower than the previous power/performance state.

If the power/performance state is lower than the previous power/performance state, the method 180 proceeds to block 188 where the method 180 sets a new operating frequency for the memory 140. The method 180 then proceeds to block 190 where the method 180 sends a different voltage setting (e.g., a power control setting 152) as a different MRS data value (e.g., 0, 1, 2, . . . n) to the memory device 140, such as via the mode register 148. The method 180 then ends at 192. On the other hand, if the power/performance state is higher than the previous power/performance state, the method 180 proceeds to block 194 where the method 180 sends a different voltage setting (e.g., a power control setting 152) as a different MRS data value (e.g., 0, 1, 2, . . . n) to the memory device 140, such as via the mode register 148. Then, the method 180 proceeds to block 196 where the method 180 sets a new operating frequency for the memory 140. The method 180 then ends at 198. FIG. 4 also shows a power mapping table 200 that illustrates an embodiment of how a processor power/performance value (e.g., 0, 1, 2, 3, 4, 5, 6, 7, . . . n) may correlate with the MRS data value and/or an operating frequency for the memory 140.

As shown in the tables 160 and 200, one may assign/standardize mode register, MRS data bits (e.g., power control signal 152), to control internal DRAM voltage. Thus, in an embodiment, as the processor 102 decreases operating frequency and power, the IHS 100, 101 may change the value of the mode register bits to decrease internal voltage which will in turn decrease power. The memory controller may decrease the memory clock frequency for additional power reduction and proper operation. In another mode, the frequency might be increased to allow higher performance as the voltage is increased. In an embodiment, a host processor 102, memory controller 130, 132, and/or a GPU 110 may be on the same die to facilitate implementation of this disclosure.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A memory device to store information, the device comprising:
a memory core to store information;
a memory controller to control storage and retrieval of the information; and
a regulator coupled to the memory controller and the memory core, wherein the regulator is operable to adjust an internal voltage to the memory core in response to commands from the memory controller.

2. The memory device of claim 1, wherein the memory device is a random access memory (RAM) device.

3. The memory device of claim 1, wherein the memory device is a dynamic random access memory (DRAM) device.

4. The memory device of claim 1, further comprising:
a mode register coupled between the memory controller and the regulator.

5. The memory device of claim 4, wherein the mode register changes a value of power control data to the regulator in response to a change in memory controller command.

6. The memory device of claim 1, wherein the memory controller is operable to adjust a memory clock frequency to the memory device to reduce power consumption of the memory device.

7. The memory device of claim 1, wherein the memory controller adjusts commands to modify the internal voltage to the memory core in response to an adjusting operating frequency of a processor coupled to the memory device.

8. An information handling system (IHS) comprising:
a processor;
a memory core to store information;
a memory controller to control storage and retrieval of the information; and
a regulator coupled to the memory controller and the memory core, wherein the regulator is operable to adjust an internal voltage to the memory core in response to commands from the memory controller.

9. The IHS of claim 8, wherein the memory device is a random access memory (RAM) device.

10. The IHS of claim 8, wherein the memory device is a dynamic random access memory (DRAM) device.

11. The IHS of claim 8, further comprising:
a mode register coupled between the memory controller and the regulator.

12. The IHS of claim 11, wherein the mode register changes a value of power control data to the regulator in response to a change in memory controller command.

13. The IHS of claim 8, wherein the memory controller is operable to adjust a memory clock frequency to the memory device to reduce power consumption of the memory device.

14. The IHS of claim 8, wherein the memory controller adjusts commands to modify the internal voltage to the memory core in response to an adjusting operating frequency of the processor.

15. A method to control a memory device comprising:
determining whether a power/performance state of an information handling system (IHS) processor has changed; and
adjusting a voltage to a memory device coupled with the processor and adjusting a memory clock frequency to the memory device, in response to the power/performance state of the processor changing.

16. The method of claim 15, further comprising:
determining whether the power/performance state of the processor has gone higher or lower than a previous power/performance state of the processor.

17. The method of claim 16, wherein the adjusting the voltage to a memory device coupled with the processor is before adjusting the memory clock frequency to the memory device, in response to the power/performance state of the processor increasing.

18. The method of claim 16, wherein the adjusting the voltage to a memory device coupled with the processor is after adjusting the memory clock frequency to the memory device, in response to the power/performance state of the processor decreasing.

19. The method of claim 15, wherein the adjusting the voltage to a memory device coupled with the processor is by adjusting a data value from a mode register to a regulator that regulates voltage to the memory device.

20. The method of claim 19, wherein the mode register adjusts the data value to the regulator in response to a command from a memory controller.
